(19) United States
(12) Patent Application Publication
(10) Pub. No.: US 2017/0246072 A1
(43) Pub. Date: Aug. 31, 2017

(54) COMPRESSION-RESISTANT DEVICE FOR THE FORMATION OF CALLUSES AND FINGER STRENGTH

(71) Applicant: Barrett Productions, LLC, Newton, MA (US)

(72) Inventor: Dennis Waldman, Newton, MA (US)

(21) Appl. No.: 15/442,890

(22) Filed: Feb. 27, 2017

Related U.S. Application Data
(60) Provisional application No. 62/299,611, filed on Feb. 25, 2016.

(51) Int. Cl. A61H 7/00

(52) U.S. Cl. CPC A61H 7/001; A61H 2205/067; A61H 2201/1253

(57) ABSTRACT

A compression-resistant device includes least one pair of first and second opposing jaw members having respective engaging surfaces for movement from an open position receiving an object and a closed position engaging the object. A manual compression surface enables a user to manually apply pressure to urge the engaging surfaces from one of the closed position towards an open position or from the open position towards the closed position. At least one resistance member interfaces with the first and second opposing jaw members to resist pressure manually applied by a user urging the engaging surfaces from the closed position towards the open position or from the open position towards the closed position. The manual compression surface includes projections such that manually applied pressure forms at least one aggravated area on a finger surface of the user to initiate a callus. A corresponding method of operating the device is also disclosed.

### BACKGROUND

Finger strength and calluses are very important in playing stringed instruments and for many sport activities like rock climbing.

### SUMMARY

To increase finger strength and to form calluses in the fingertips, in embodiments of the present disclosure, a compression-resistant device includes at least one pair of first and second opposing jaw members. The first and second opposing jaw members have respective engaging surfaces associated therewith. The first and second jaw members are adapted for relative movement of the engaging surfaces between an open position configured to receive an object and a closed position configured to engage the object between the engaging surfaces. At least one of the first and second opposing jaw members has a manual compression surface configured to enable a user to manually apply pressure to urge the engaging surfaces from one of the closed position towards an open position or from the open position towards the closed position.

At least one resistance member is configured and disposed to interface with the first and second opposing jaw members to resist pressure manually applied by a user urging the engaging surfaces from the closed position towards the open position or from the open position towards the closed position The manual compression surface of the one or both first and second jaw members includes projections extending therefrom and intermittent gaps therebetween such that the manually applied pressure forms at least one callus on a finger surface of the user.

In embodiments of the present disclosure, a method of operating a compression-resistant device includes providing a compression-resistant device adapted for relative movement of engaging surfaces between an open position to receive an object and a closed position engaging the object between the engaging surfaces and including at least one manual compression surface enabling a user to manually apply pressure to urge the engaging surfaces from one of the closed position towards an open position or from the open position towards the closed position, the at least one manual compression surface including projections extending therefrom and intermittent gaps therebetween; operating the compression-resistant device to resist pressure manually applied by a user urging the engaging surfaces from the closed position towards an open position or from an open position towards the closed position; and forming at least one callus in the user via the manually applied pressure against the at least one manual compression surface that includes projections extending therefrom and intermittent gaps therebetween.

### BRIEF DESCRIPTION OF THE DRAWINGS

The advantages and features of the present disclosure will become more appreciated and better understood when considered in conjunction with the drawings:

FIG. 1 illustrates a hand of a user of a compression-resistant device according to embodiments of the present disclosure wherein the index and middle finger of the user are extended and illustrate one or more calluses formed at the finger tips via the compression-resistant device;

FIG. 2 is a close-up enlarged view of the fingers and finger tips of the user of FIG. 1 showing the one or more calluses formed at the finger tips via the compression-resistant device;

FIG. 3 is a perspective view of a compression-resistant device in a closed position according to one embodiment of the present disclosure;

FIG. 4 is a plan close-up partial view of a manual compression surface of the compression-resistant device wherein the manual compression surface includes a pattern of projections and protrusions that emulates a surface of wound guitar strings;

FIG. 5 is a cross-section view of pattern of projections and protrusions of the compression-resistant device taken along section line 5-5 of FIG. 4;

FIG. 6 is a rear or proximal perspective view of the compression-resistant device of FIG. 5;

FIG. 7 is a front or distal perspective view of the compression-resistant device of FIG. 5;

FIG. 8 is a side view of the compression-resistant device being held by the hand of a user while in the closed position;

FIG. 9 is an upper perspective view of the compression-resistant device of FIG. 8 being held by the hand of a user while in the closed position;

FIG. 10 is a perspective view of the compression-resistant device showing one jaw member having a manual compression grasping surface wherein the grasping surface is relatively smooth and is not designed to form calluses;

FIG. 11 is a perspective view of the compression-resistant device being held by the hand of a user in an open position illustrating an engaging surface of one of the jaw members;

FIG. 12 is a front or distal view of the jaw members of the compression-resistant device being held in the an open position illustrating engaging surfaces on both jaw members and a cavity housing a resistance member;

FIG. 13 is a side view of the compression-resistant device being in a partially open position being held in the hand of a user such that the palm of the user compresses a grasping surface that is relatively smooth and is not designed to form calluses while all four fingers of the user compress the manual compression surface that is designed to form calluses;

FIG. 14 is a side view of guitar strings having a coiled configuration that induces calluses in a user which are the type intended to be induced in a user of the compression-resistant device:

FIG. 15 is a perspective view of the guitar strings of FIG. 14;

FIG. 16 is a close-up view of one of the guitar strings of FIGS. 14 and 15 showing the coiled configuration;

FIG. 17 illustrates the fingertips of the right hand of a user having indentations that are similar to indentations formed by playing the guitar strings of FIGS. 14-16 after the user has used the compression-resistant device;

FIG. 18 illustrates the fingertips of the left hand of a user having indentations similar to those illustrated in FIG. 17;

FIG. 19A is a perspective view of a handle covering for the compression-resistant device wherein the handle covering in FIG. 10 includes the manual compression surface having a pattern of protrusions that is the same as the pattern illustrated in FIGS. 3-9, 11 and 13 that emulates a surface of wound guitar strings;

FIG. 19B illustrates the handle covering without the protrusions;

FIG. 19C is partial view of a bare handle of the compression-resistant device illustrating the protrusions projecting from the handle;

FIG. 20 is a perspective view of a handle covering for the compression-resistant device wherein the handle covering includes a manual compression surface having another pattern of protrusions that differs from the pattern illustrated in FIGS. 3-9, 11 and 13 wherein the pattern is that of alternating pointed and round tips;

FIG. 21 is a perspective view of a handle covering for the compression-resistant device wherein the handle covering includes a manual compression surface having yet another pattern of protrusions that differs from the pattern illustrated in FIGS. 3-9, 11 and 13 wherein the pattern is that of a fine knurled surface;

FIG. 22 is a perspective view of a handle covering for the compression-resistant device wherein the handle covering includes a manual compression surface having still another pattern of protrusions that differs from the pattern illustrated in FIGS. 3-9, 11 and 13 wherein the pattern is that of coarse knurled surface;

FIG. 23 is a perspective view of a handle covering for the compression-resistant device wherein the handle covering includes a manual compression surface having another pattern of protrusions that differs from the pattern illustrated in FIGS. 3-9, 11 and 13 wherein the pattern is that of a sharp uneven knurled surface;

FIG. 24 is a perspective view of a handle covering for the compression-resistant device wherein the handle covering includes a manual compression surface having another pattern of protrusions that differs from the pattern illustrated in FIGS. 3-9, 11, 13 and 19(a)-19(c) wherein the pattern is that of the pattern of protrusions that emulates a surface of wound guitar strings but in the form of sequential interlocking Xs;

FIG. 25 is a perspective view of another embodiment of the compression-resistant device wherein the manual compression surface further defines a boundary structure extending from the manual compression surface such that the intermittent gaps are bounded by the manual compression surface and by the boundary structure;

FIG. 26 illustrates an alternative use for the compression-resistant devices wherein the engaging surfaces are applied to clip or maintain in place sheets of music on a musical lyrics stand; and

FIG. 27 is an alternate embodiment of the compression-resistant device wherein the compression-resistant device is configured to resist pressure manually applied by a user urging the engaging surfaces from an open position towards the closed position.

### DETAILED DESCRIPTION

As described above, finger strength and calluses are very important in playing stringed instruments and for many sport activities like rock climbing.

The present disclosure relates to a resistive pinch clip or compression-resistant device that can build both finger strength and calluses on the finger tips.

By applying pressure with one or more fingers to the Callus Pinch Clip or compression-resistant device, finger muscle development can be achieved. Resistance is determined by a torsion spring. Different resistant level units can be manufactured by changing the torsion spring.

Users can also build calluses more effectively when applying force with the user's fingertips against the raised ribbed spiral design on the upper piece of the pinch clip. The design is similar to that of a guitar string. It is very important that the user be pushing against a resistive force (provided by the torsion spring) so that the raised ribbed section pushes into the finger tips.

After just a short period (less than a minute) indentations can be seen on the finger tips. These indentations are similar to what the user would see when practicing with a guitar.

In addition, the compression-resistant resistive pinch clip is useful for tactile sensory input. Those with carpal tunnel syndrome lose sensory feelings in their fingertips. The compression-resistant device can help stimulate those senses. The sensitivity of the fingertips to contact may be significantly increased or decreased. The compression resistant device may increase contact tolerance for those experiencing hypersensitive fingertips.

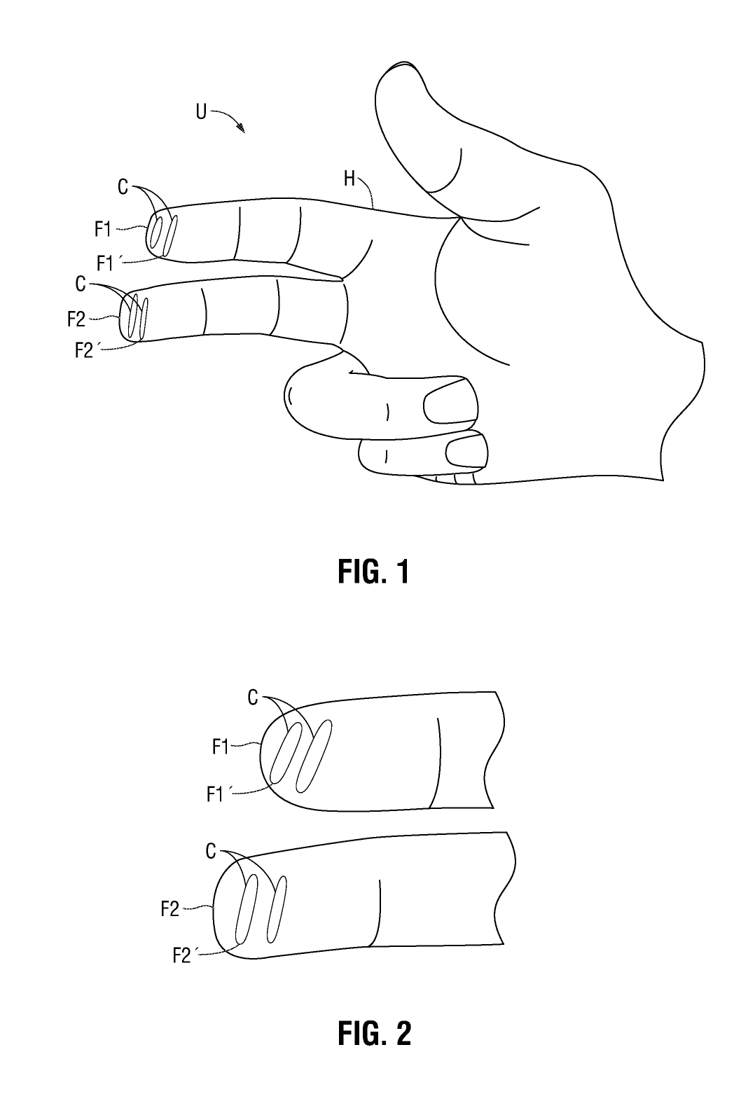

Turning now to FIG. 1 there is illustrated a hand H of a user U of a compression-resistant device according to embodiments of the present disclosure wherein the index finger F1 and middle finger F2 of the user U are extended and illustrate one or more aggravated areas or indentations C that are precursors to calluses formed at the fingertips or finger surfaces F1′, F2′, respectively, via repetitive usage of the compression-resistant device. Initial usage of the compression-resistant device forms the aggravated areas or indentations C which ultimately may become calluses upon sufficient repetitive usage of the compression-resistant device. The amount of repetitive usage required to form calluses is specific to such factors as each user's strength and skin condition at the fingertips or other medical factors.

FIG. 2 is a close-up enlarged view of the fingers F1 and F2 and finger tips or finger surfaces F1′, F2′ of the user U of FIG. 1 showing the one or more aggravated areas or indentations C that are precursors to calluses formed at the fingertips or finger surfaces F1′, F2′ via the compression-resistant device.

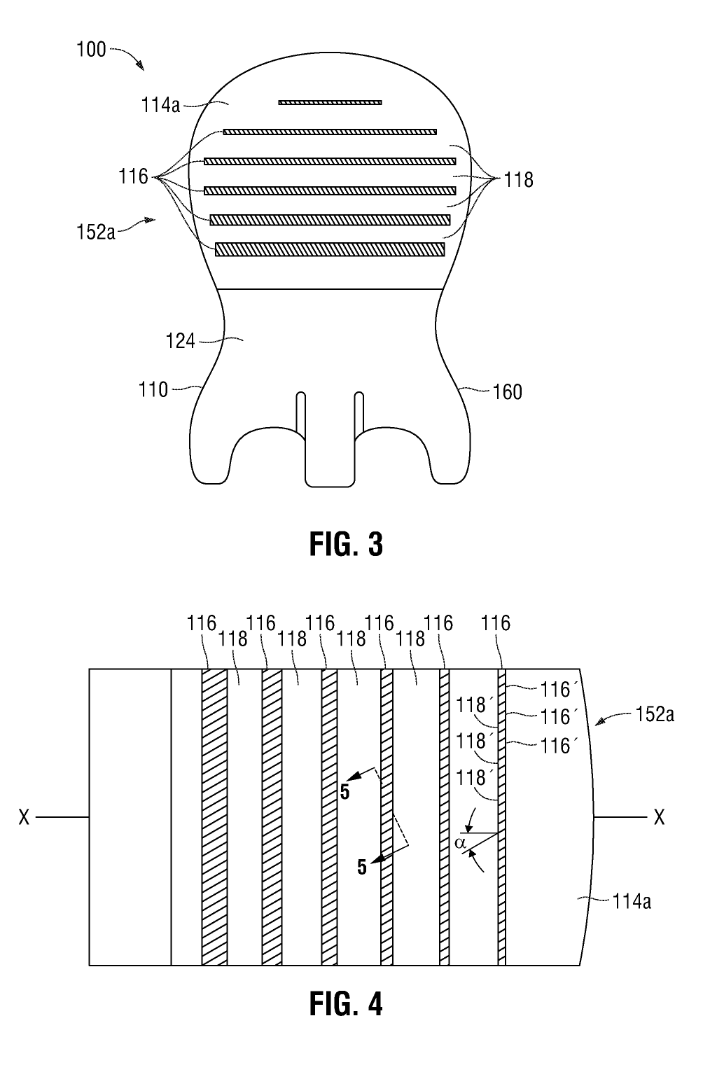

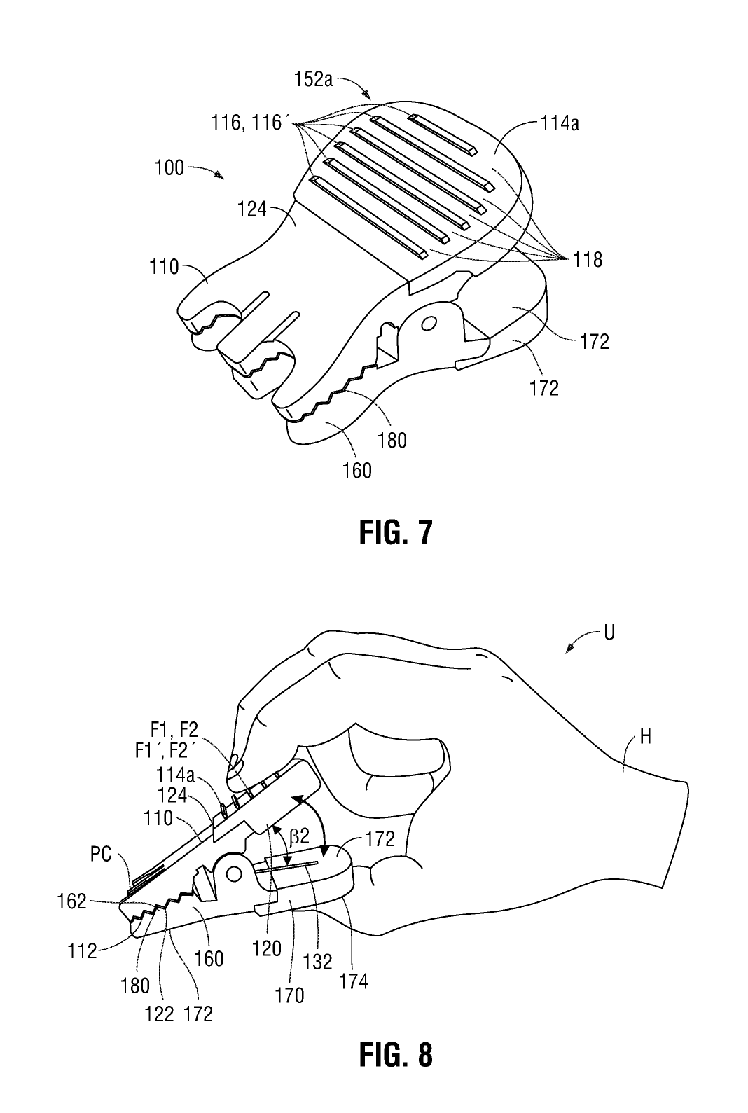

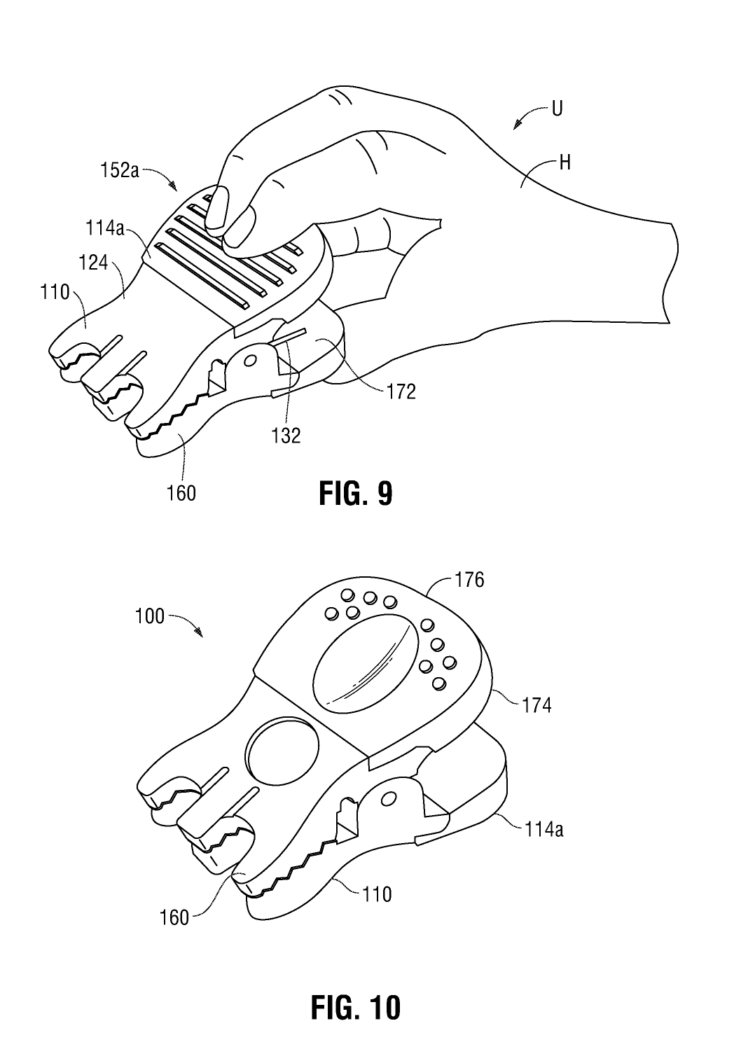

FIGS. 3-9 illustrate at least one compression-resistant device 100 according to one embodiment of the present disclosure.

In FIG. 3, compression-resistant device 100 includes at least one pair of first and second opposing jaw members 110 and 160, respectively.

At least one of the first and second opposing jaw members 110 has a manual compression surface 114a configured to enable the user U to manually apply pressure to urge the engaging surfaces 112 and 162 from the closed position PC towards an open position PO or from the open position PO towards the closed position PC.

As best shown in FIG. 6, at least one resistance member 130 is configured and disposed to interface with the first and second opposing jaw members 110 and 160, respectively, to resist pressure manually applied by the user U when urging the engaging surfaces 112 and 162 from the closed position PC towards an open position PO or from an open position PO towards the closed position PC. (The latter embodiment is illustrated and described below with respect to FIG. 27). The first and second opposing jaw members 110 and 160 are generally plate-like structures with a generally planar inner or retaining side 122 and a generally planar outer side 124 with respect to first jaw member 110 and a generally planar inner or retaining side 172 and a generally planar outer side 174 and form an angle α with respect to each other and intersect along a vertex V. The resistance member 130 may be, as shown in FIG. 6, as one example, in the form of a torsion spring with an extended arm 131 that interfaces with inner or retaining side 122 of first jaw member 110 and an extended arm 132 that interfaces with inner or retaining side 172 of second jaw member 160. The resistance member 130 is positioned in a cavity 140 defined between the retaining sides 122 and 172. The arms 131 and 132 extend through an aperture 140′ configured to enable access to the cavity 140 and formed between a first hinge member 142a and a second hinge member 142b that are co-linear along the vertex V. The cavity 140 and aperture 140′ are configured and disposed to enable the extended arm 131 to interface with retaining side 122 and extended arm 132 to interface with retaining side 172. The extended arms 131 and 132 form an angle α′ with respect to their positions on the vertex V and to each other that is greater than angle α.

As best shown in FIGS. 3, 4 and 5, projections 116 extend from the manual compression surface 114a which define intermittent gaps 118 between the projections 116 such that the manually applied pressure forms at least one callus C in the user U.

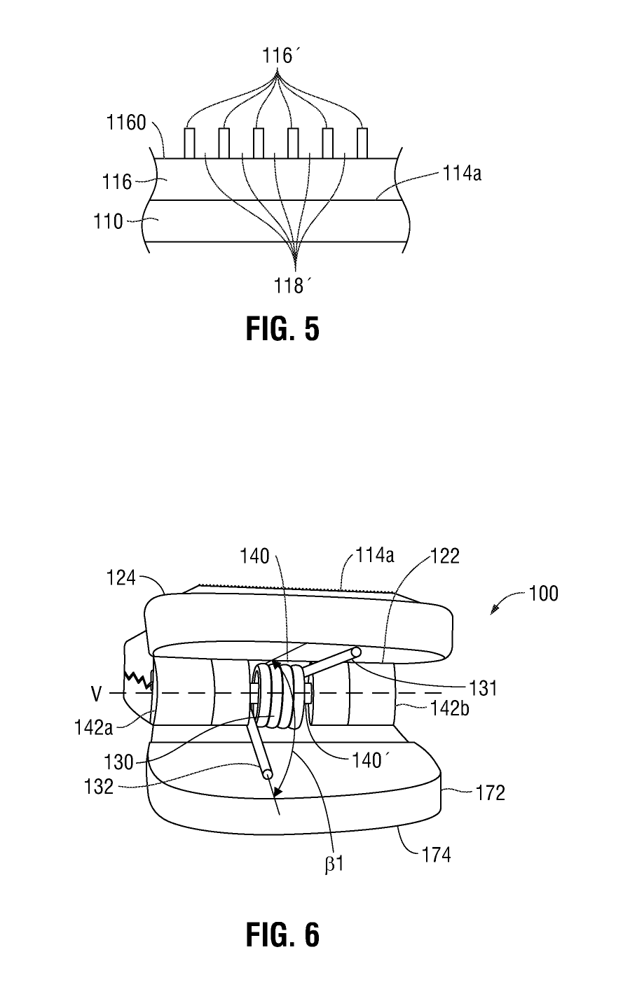

In one embodiment, as best shown in FIG. 5, the projections 116 from the manual compression surface 114a of at least one of the first and second jaw members 110 or 160 extend across the manual compression surface 114a such that the intermittent gaps 118 are bounded only by the manual compression surface 114a.

As best shown in FIGS. 8, 10, 11 and 12, the manual compression surface 114a is configured and disposed on a side of at least one of the first and second jaw members 110 and 160, respectively, that is opposite to a side of each of the first and second jaw members 110 and 160 on which are configured and disposed the engaging surfaces 112 and 162, respectively. More particularly, in FIG. 8, manual compression surface 114a is configured and disposed on side 120 that is opposite to retaining side 122 on which is configured and disposed engaging surface 112. In the embodiment of the compression-resistant device 100 as illustrated in FIG. 8, there is no manual compression surface configured and disposed on retaining side 172 that is opposite to engaging surface 162 of the second jaw member 160.

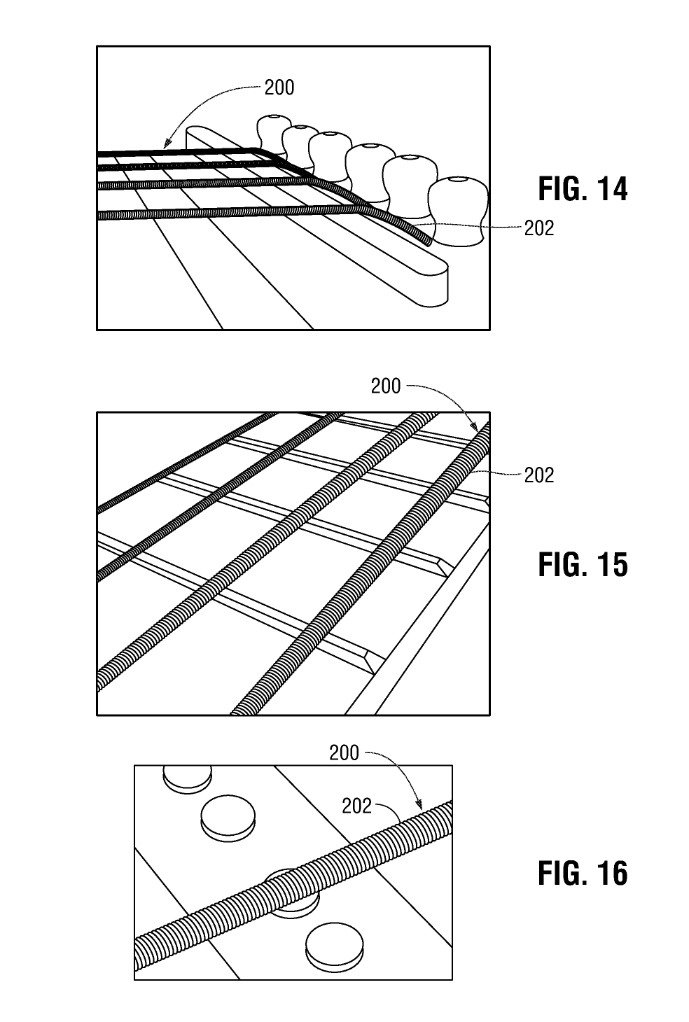

As best illustrated in FIGS. 4 and 5, the projections 116 extend from the manual compression surface 114a extend as solid rectangular projections separated by the intermittent gaps 118 between the projections 116. The solid rectangular projections 116 therefore define upper edges 1160 that extend in a direction that is generally parallel to the manual compression surface 114a. In order to induce calluses in a user of the compression-resistant device 100, additional projections 116′ extend from the upper edges 1160 and are separated along the upper edges 1160 by intermittent gaps 118′. The additional projections 116′ are configured and disposed on the upper edges 1160 configured as diagonal parallel lines that are offset by angle α with respect to centerline axis X-X of the compression-resistant device 100. Therefore, the manual compression surface 114a includes a pattern of protrusions 152a that emulates a surface of wound guitar strings as further described below with respect to FIGS. 14-16. As best illustrated in FIGS. 3 and 7-9, the engaging surfaces 112 and 162 may further include intermeshing teeth 180 that are configured and disposed to enable gripping of the object O received therebetween. The object O may include a sheet of music or notes or other desired object that may facilitate playing of a guitar or similar musical instrument which would be benefitted by the user developing calluses.

FIG. 10 is a perspective view of the compression-resistant device 100 showing second jaw member 160 having manual compression grasping surface 174 disposed thereon wherein the grasping surface is relatively smooth and is not designed to form calluses. The grasping surface 174 includes a central depression 176 defined therein to facilitate one method of usage of the device wherein the user applies his or her thumb in the central depression 176.

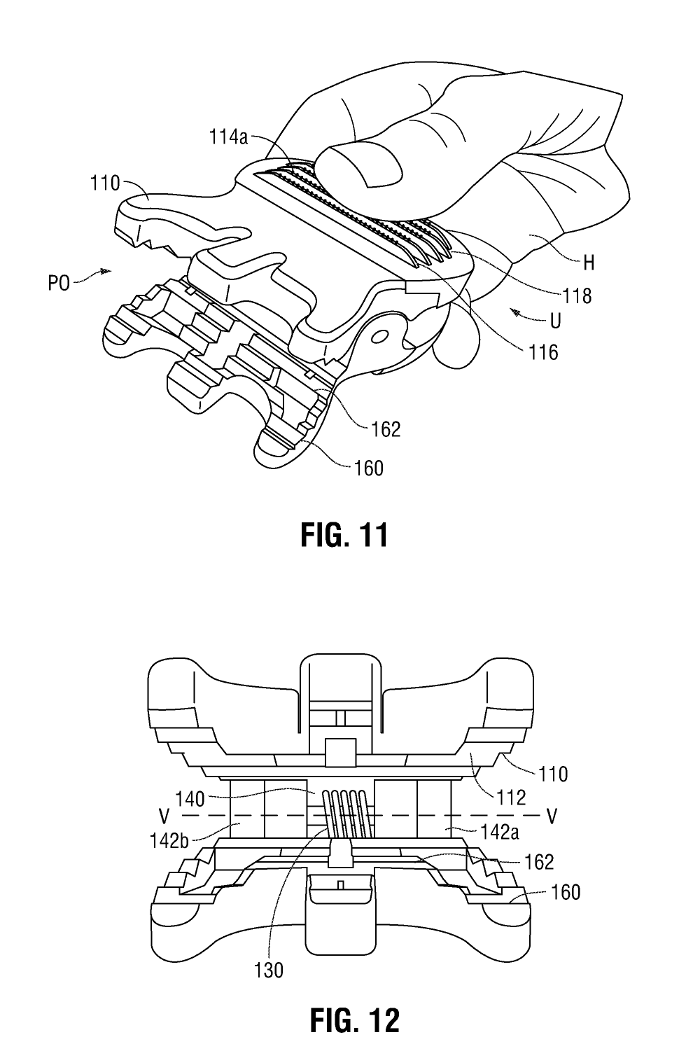

FIG. 11 is a perspective view of the compression-resistant device 100 being held by the hand H of a user U in an open position and compressing manual compression surface 114 on first jaw member 110 and illustrating engaging surface 162 of second jaw member 160.

FIG. 12 is a front or distal view of the jaw members 110 and 160 of the compression-resistant device 100 being held in the an open position PO illustrating engaging surfaces 112 and 162 on both jaw members 110 and 160, respectively, and the opposite side of cavity 140 housing resistance member 130 (see FIG. 6). As compared to FIG. 6, first hinge member 142a and second hinge member 142b are again co-linear along the vertex V but appear on opposite sides of the drawing.

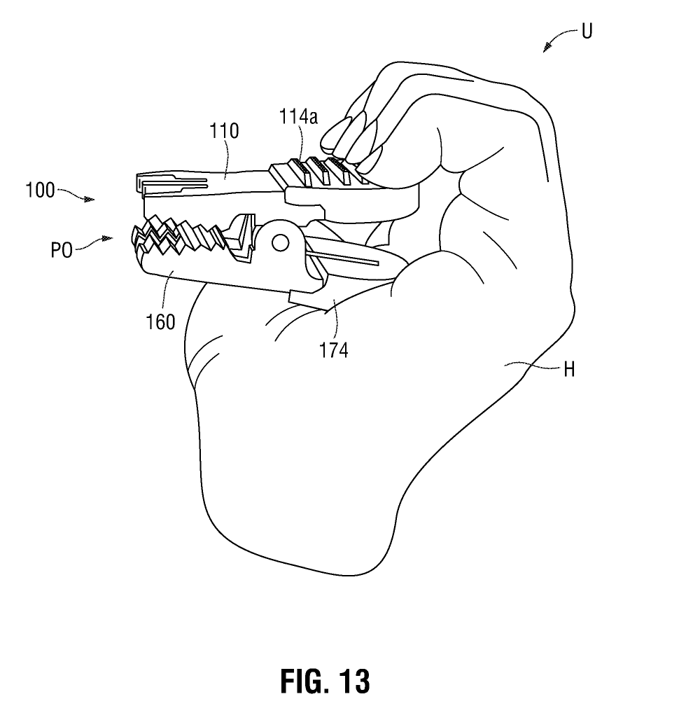

FIG. 13 is a side view of the compression-resistant device 100 being in a partially open position PO being held in the hand H of a user U such that the palm of the user compresses grasping surface 174 (see FIG. 10) that is relatively smooth and is not designed to form calluses while all four fingers of the user compress the manual compression surface 114a that is designed to form calluses.

As defined herein, open position PO is defined as a position of the compression-resistant device that is not in the closed position PC wherein the engaging surfaces 112 and 162 are in contact with each other.

FIG. 14 is a side view of guitar strings 200 having a coiled configuration 202 that induces calluses in a user which are the type intended to be induced in a user of the compression-resistant device 100 and which is induced by the pattern of protrusions 152a that emulates the coiled configuration 202 as described above with respect to FIGS. 1-9 and 13.

FIG. 15 is a perspective view of the guitar strings 200 of FIG. 14.

FIG. 16 is a close-up view of one of the guitar strings 200 of FIGS. 14 and 15 showing the coiled configuration 202.

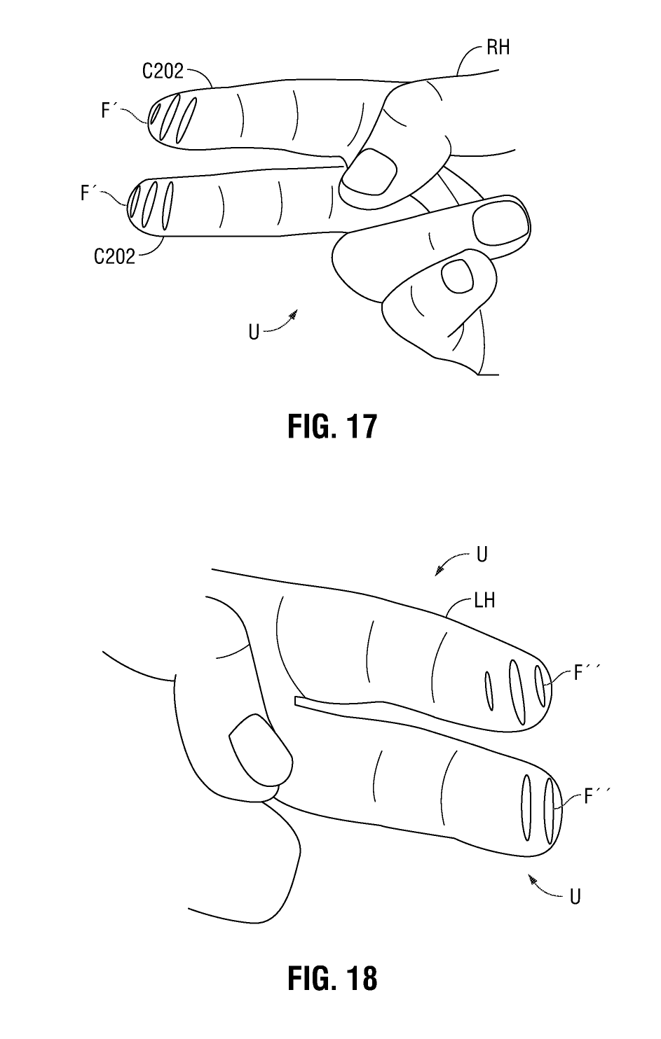

FIG. 17 illustrates the fingertips F′ of the right hand RH of a user U having indentations C202 that are similar to indentations formed by playing the coiled guitar strings 200 of FIGS. 14-16 after the user U has used the compression-resistant device 100.

FIG. 18 illustrates the fingertips F″ of the left hand LH of a user U having indentations similar to those illustrated in FIG. 17 following usage of the compression-resistant device 100.

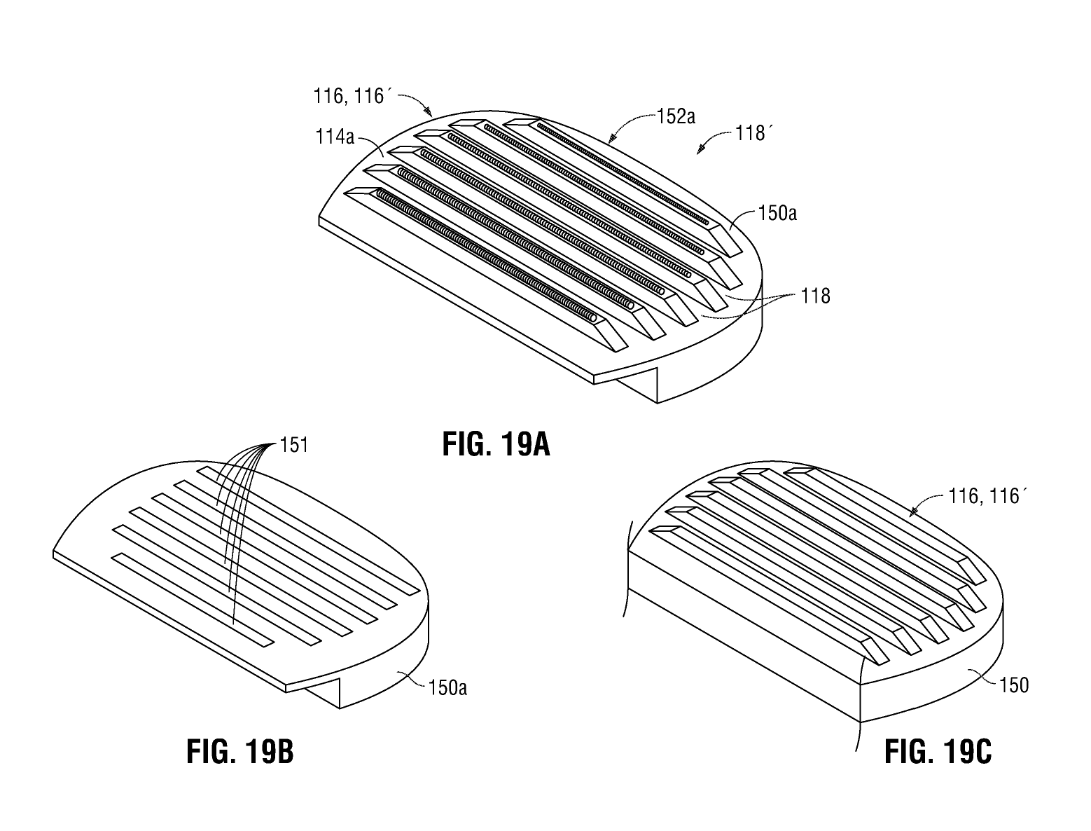

FIG. 19A is a perspective view of a handle covering 150a for the compression-resistant device 100 wherein the handle covering 150a includes manual compression surface 114a having the same pattern 152a of protrusions illustrated in FIGS. 3-9, 11 and 13 wherein the pattern 152a emulates a coiled surface of wound guitar strings.

FIG. 19B illustrates the handle covering 150a without the protrusions 116 and includes a series of apertures or slots 151 defined in the handle covering 150a to enable the protrusions 116 and additional projections 116′ to penetrate therethrough.

FIG. 19C is a partial view of a bare handle 150 of the compression-resistant device illustrating the protrusions 116 and additional projections 116′ projecting from the handle 150. The bare handle 150 therefore is overmolded with the handle covering 150a.

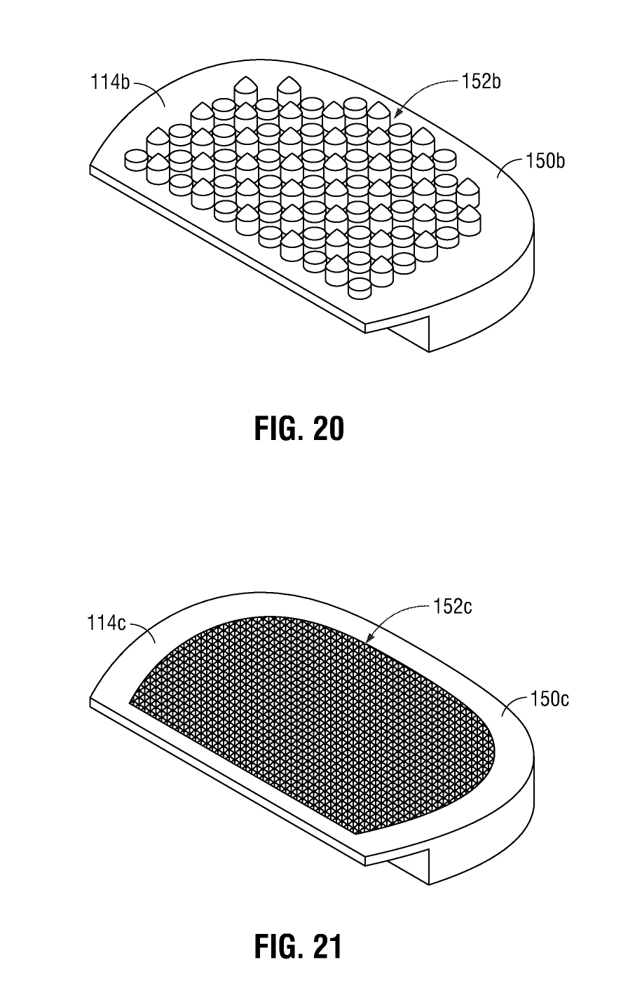

FIG. 20 is a perspective view of a handle covering 150b for the compression-resistant device 100 wherein the handle covering 150b includes a manual compression surface 114b having another pattern 152b of protrusions that differs from the pattern 152 illustrated in FIGS. 3-9, 11, 13 and 19A-19C wherein the pattern 152b is that of alternating pointed and round tips 152b1 and 152b2, respectively.

FIG. 21 is a perspective view of a handle covering 150c for the compression-resistant device 100 wherein the handle covering 150c includes a manual compression surface 114c having yet another pattern 152c of protrusions that differs from the pattern 152 illustrated in FIGS. 3-9, 11 and 13 wherein the pattern 152c is that of a fine knurled surface of pointed pyramidal projections 152c′.

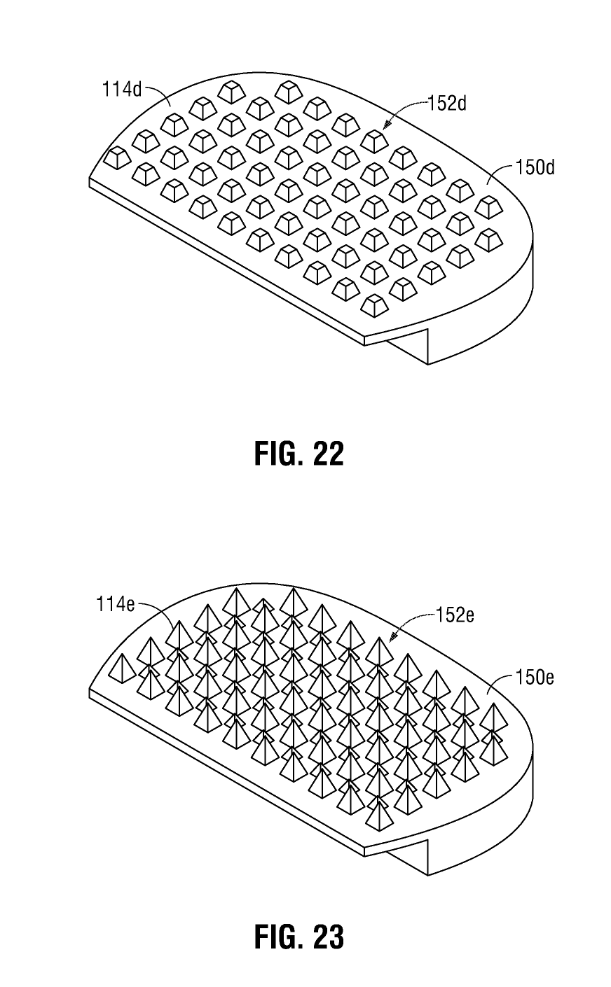

FIG. 22 is a perspective view of a handle covering 150d for the compression-resistant device 100 wherein the handle covering 150d includes a manual compression surface 114d having another pattern 152d of protrusions that differs from the pattern 152 illustrated in FIGS. 3-9, 11 and 13 wherein the pattern 152d is that of a coarse knurled surface of flat topped pyramidal projections 152d′.

FIG. 23 is a perspective view of a handle covering 150e for the compression-resistant device 100 wherein the handle covering 150e includes a manual compression surface 114e having another pattern 152e of protrusions that differs from the pattern 152 illustrated in FIGS. 3-9, 11 and 13 wherein the pattern 152e is that of a sharp uneven knurled surface of alternating pyramids of two different heights 152e1 and 152e2, respectively.

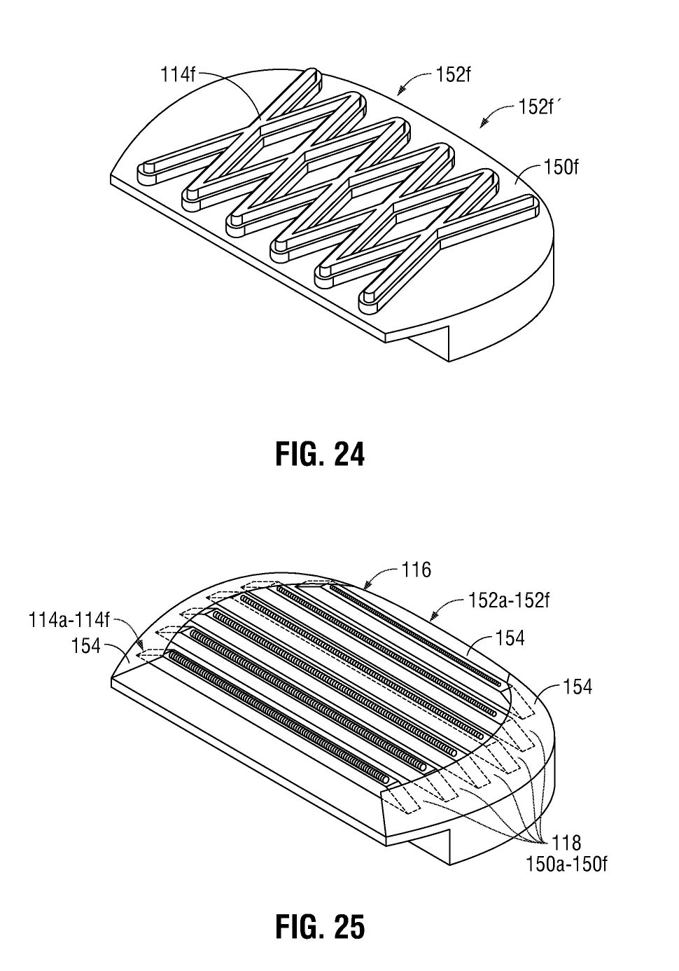

FIG. 24 is a perspective view of a handle covering 150f for the compression-resistant device 100 wherein the handle covering 150f includes a manual compression surface 114f having another pattern 152f of protrusions that differs from the pattern 152a illustrated in FIGS. 3-9, 11 and 13 wherein the pattern 152f is that of the pattern of protrusions 152a that emulates a surface of wound guitar strings as described above most particularly with respect to, and shown in, FIG. 4, but in the form of sequential interlocking Xs 152f.

It can be understood that, while not explicitly shown, the handle coverings 150b-150f can be overmolded onto respective bare handles of the compression-resistant device 100 in the same manner as described above with respect to FIGS. 19(a)-19(c) wherein the bare handle 150, having pattern of protrusions 152a, is overmolded with the handle covering 150a.

In embodiments, as illustrated in FIG. 25, the manual compression surface 114a further defines a boundary structure 154 extending from the manual compression surface 114a such that the lateral ends of the intermittent gaps 118 are bounded by the manual compression surface 114a and by the boundary structure 154.

It can be understood therefore that the boundary structure 154 can bound any of the manual compression surfaces 114a-114f or similar manual compression surfaces as described above.

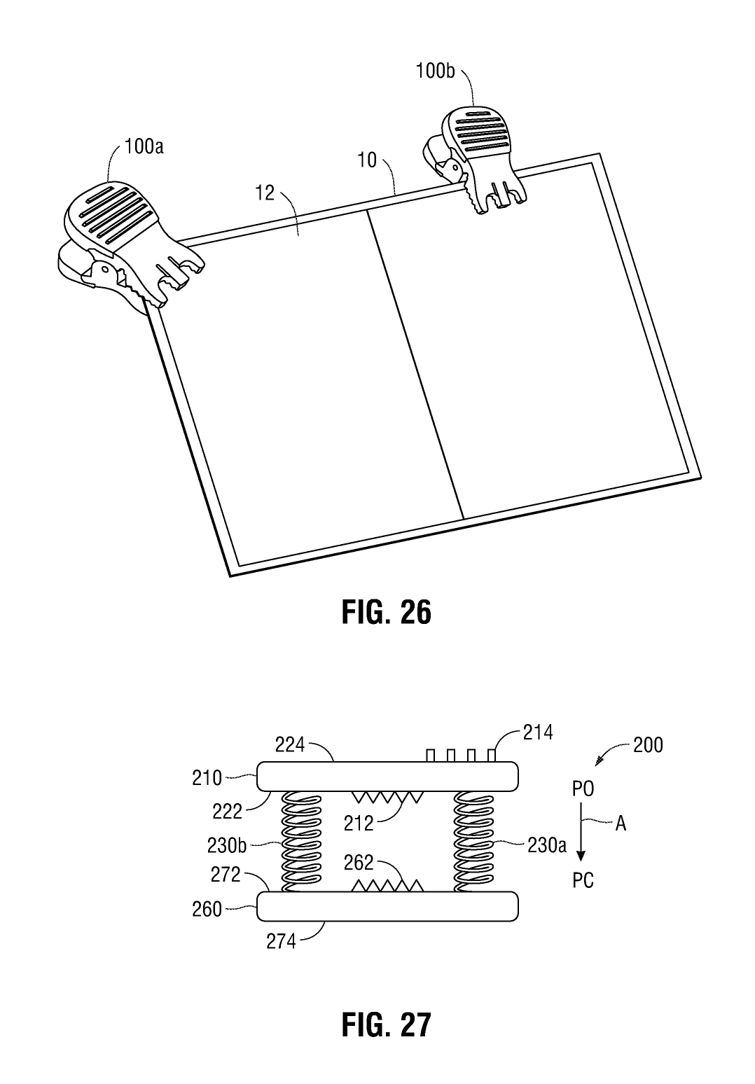

FIG. 26 illustrates an alternative use for the compression-resistant devices 100a and 100b, that are configured in the same manner as compression-resistant device 100 and may include any of the manual compression surfaces 114a-114f, wherein the engaging surfaces engaging surfaces 112 and 162 are applied to clip or maintain in place sheets of music 12 on a musical lyrics stand 10.

FIG. 27 is an alternate embodiment of the compression-resistant device 100 wherein compression-resistant device 200 is configured to resist pressure manually applied by a user urging the engaging surfaces 212 and 262 of first and second jaw members 210 and 260, respectively, from an open position PO towards the closed position PC, as shown by arrow A. In a similar manner as with respect to compression-resistant device 100, the first and second opposing jaw members 210 and 260 are generally plate-like structures with a generally planar inner or retaining side 222 and a generally planar outer side 224 with respect to first jaw member 210 and a generally planar inner or retaining side 272 and a generally planar outer side 274. The first and second jaw members 210 and 260 are interconnected via at least one resistance member 230a and may include a second resistance member 230b that are each disposed between the generally planar inner side 222 of jaw member 210 and the generally planar inner side 272 of jaw member 260 and thus are configured and disposed to interface with the first and second jaw members 210 and 260 to resist pressure manually applied by a user urging the engaging surfaces 212 and 262 of first and second jaw members 210 and 260, respectively, from an open position PO towards the closed position PC, as shown by arrow A. In the embodiment of device 200 illustrated in FIG. 27, manual compression surface 214 is disposed on outer side 224 towards one end of the jaw member 210. In this configuration, at least one compression-resistant resistance member 230a is disposed generally aligned with the manual compression surface 214 towards one end of the jaw members 210 and 260 while a second resistance member 230b that is tension-resistant is disposed between the first and second jaw members 210 and 260 towards the other ends of those jaw members. Upon a user grasping the compression-resistant device 200 via the manual compression surface 214 on first jaw member 210 and via the outer side 274 of the second jaw member 260, one end of each of the first and second jaw members 210 and 260, respectively, may be transferred from an open position PO towards the closed position PC, as shown by arrow A while the opposite end of the first and second jaw members 210 and 260 may travel away from each other increasing the distance therebetween under the control of the tension-resistant resistance member 230b.

In an alternate embodiment, not shown, the engaging surfaces 212 and 262 may be omitted.

In still another alternate embodiment, not shown, the manual compression surface 214 may be positioned at the center of the first jaw member 210 between the opposing ends and a single compression-resistant resistance member 230a may be aligned with the center between the opposing ends of the first jaw member 210 and with the center between opposing ends of the second jaw member 260.

As a result of the foregoing disclosure, in embodiments, referring to FIGS. 1-27, the present disclosure relates to a method of operating a compression-resistant device that includes providing a compression-resistant device, e.g., compression-resistant device 100, that is adapted for relative movement of engaging surfaces, e.g., engaging surfaces 112 and 162, between an open position, e.g., open position PO, to receive an object, e.g., object O, and a closed position, e.g., closed position PC, engaging the object O between the engaging surfaces, e.g. engaging surfaces 112 and 162, and including at least one manual compression surface, e.g., manual compression surface 114, enabling a user, e.g., user U, to manually apply pressure to urge the engaging surfaces, e.g., engaging surfaces 112 and 162, from one of the closed position PC towards an open position PO or from the open position PO towards the closed position PC wherein the at least one manual compression surface, e.g., manual compression surface 114, includes projections, e.g., projections 116, extending therefrom and intermittent gaps, e.g., intermittent gaps 118, therebetween.

The method includes forming at least one callus, e.g. in FIGS. 1 and 3, calluses C in the user U, via the manually applied pressure against the at least one manual compression surface, e.g., manual compression surface 114a-114f, that includes projections, e.g., projections 116, extending therefrom and intermittent gaps, e.g., intermittent gaps 118, therebetween.

Operation of the compression-resistant device, e.g., compression-resistant device 100, to resist pressure manually applied by a user U urging the engaging surfaces, e.g., engaging surfaces 112 and 162, from the closed position PC towards an open position PO may include operating a torsion resistance member, e.g., torsion resistance member 130, to resist pressure manually applied by the user U urging the engaging surfaces, e.g., engaging surfaces 112 and 162, from the closed position PC towards an open position PO.

In embodiments, alternatively, operation of the compression-resistant device, e.g., compression-resistant device 200 in FIG. 27, to resist pressure manually applied by a user U urging the engaging surfaces, e.g., engaging surfaces 212 and 262, from an open position PO towards the closed position PC may include operating at least first and second resistance members 230a and 230b, respectively, to resist pressure manually applied by a user urging the engaging surfaces 212 and 262 from an open position PO towards the closed position PC.

In embodiments, again referring to FIG. 27, the method may further include wherein operating the compression-resistant device 200 to resist pressure manually applied by a user includes applying pressure wherein at least one of the at least first and second resistance members 230a and 230b, respectively, resists compression, e.g., first resistance member 230a.

In embodiments, the method may further include wherein operating the compression-resistant device 200 to resist pressure manually applied by a user includes applying pressure wherein at least one of the at least first and second resistance members 230a and 230b, respectively, resists tension, e.g., second resistance member 230b.

Referring to previous figures, e.g., FIGS. 3-9 and FIGS. 19-24, the method may further include, wherein the operation of the compression-resistant device, e.g., compression-resistant device 100, to resist pressure manually applied by a user U includes applying pressure against projections from the manual compression surface that extend across the manual compression surface, e.g., projections 116 that extend across manual compression surface 114, such that the intermittent gaps, e.g., intermittent gaps 118, are bounded only by the manual compression surface, e.g., manual compression surface 114.

The method may include, wherein operating the compression-resistant device 100 to resist pressure manually applied by a user includes applying pressure against the projections, e.g., projections 116, from the manual compression surface 114a-114f or 114f′ that extend across the manual compression surface 114a-114f that are bounded by a boundary structure 154 extending from the manual compression surface 114a-114f such that the intermittent gaps 118 are bounded by the manual compression surface 114a-114f and by the boundary structure 154.

The method may include, wherein the manual compression surface 114a-114f is configured and disposed on a side 124 of at least one of the first and second jaw members 110 and 160 that is opposite to a side 122 and 172 of each of the first and second jaw members 110 and 160 on which are configured and disposed the engaging surfaces 112 and 162.

The method may further include, wherein the operation of the compression-resistant device, e.g., compression-resistant device 100, to resist pressure manually applied by a user U includes applying pressure against projections, e.g., protrusions 116′, that are configured as diagonal parallel lines 116′ that are offset by angle α with respect to centerline axis X-X of the compression-resistant device 100. The method may further include, wherein the operation of the compression-resistant device, e.g., compression-resistant device 100, to resist pressure manually applied by a user U includes applying pressure wherein the engaging surfaces, e.g., engaging surfaces 112 and 162, intermesh teeth, e.g., intermeshing teeth 180, to enable gripping of an object, e.g., object O such as a sheet of music, etc., received therebetween.

Although the present disclosure has been described in considerable detail with reference to certain embodiments, other embodiments and versions are possible and contemplated. Therefore, the spirit and scope of the appended claims should not be limited to the description of the embodiments contained herein.

What is claimed is:

1. A compression-resistant device comprising:
at least one pair of first and second opposing jaw members,
the first and second opposing jaw members having respective engaging surfaces associated therewith, said first and second jaw members adapted for relative movement of the engaging surfaces between an open position configured to receive an object and a closed position configured to engage the object between the engaging surfaces,
at least one of the first and second opposing jaw members having a manual compression surface configured to enable a user to manually apply pressure to urge the engaging surfaces from one of the closed position towards an open position or from the open position towards the closed position; and
at least one resistance member configured and disposed to interface with the first and second opposing jaw members to resist pressure manually applied by a user urging the engaging surfaces from the closed position towards the open position or from the open position towards the closed position, the manual compression surface of the at least one of the first and second jaw members including projections extending therefrom and intermittent gaps therebetween such that the manually applied pressure forms an aggravated area on a finger surface of the user, the aggravated area a precursor to formation of at least one callus on the finger surface of the user upon repetitive pressure manually applied by the user urging the engaging surfaces from the closed position towards the open position or from the open position towards the closed position.

2. The compression-resistant device according to claim 1,
wherein the at least one resistance member is a torsion resistance member configured and disposed to interface with the first and second jaw members to resist pressure manually applied by a user urging the engaging surfaces from the closed position towards an open position.

3. The compression-resistant device according to claim 1,
wherein the at least one resistance member includes at least first and second resistance members that are configured and disposed to interface with the first and second jaw members to resist pressure manually applied by a user urging the engaging surfaces from an open position towards the closed position.

4. The compression-resistant device according to claim 1,
wherein the projections from the manual compression surface of at least one of the first and second jaw members extend across the manual compression surface such that the intermittent gaps are bounded only by the manual compression surface.

5. The compression-resistant device according to claim 1,
wherein the manual compression surface further defines a boundary structure extending from the manual compression surface such that the intermittent gaps are bounded by the manual compression surface and by the boundary structure.

6. The compression-resistant device according to claim 1, wherein the manual compression surface is configured and disposed on a side of at least one of the first and second jaw members that is opposite to a side of each of the first and second jaw members on which are configured and disposed the engaging surfaces.

7. The compression-resistant device according to claim 1, wherein the projections extending from the manual compression surface and intermittent gaps between the projections define a spiral cross-sectional configuration.

8. The compression-resistant device according to claim 2,
wherein the engaging surfaces further include intermeshing teeth configured and disposed to enable gripping of the object received therebetween.

9. The compression-resistant device according to claim 3,
wherein at least one of the at least first and second resistance members resists compression.

10. The compression-resistant device according to claim 3,
wherein at least one of the at least first and second resistance members resists tension.

11. A method of operating a compression-resistant device comprising:
providing a compression-resistant device adapted for relative movement of engaging surfaces between an open position to receive an object and a closed position engaging the object between the engaging surfaces and including at least one manual compression surface enabling a user to manually apply pressure to urge the engaging surfaces from one of the closed position towards an open position or from the open position towards the closed position, the at least one manual compression surface including projections extending therefrom and intermittent gaps therebetween;
operating the compression-resistant device to resist pressure manually applied by a user urging the engaging surfaces from the closed position towards an open position or from an open position towards the closed position; and
forming at least one aggravated area in the user via the manually applied pressure against the at least one manual compression surface that includes projections extending therefrom and intermittent gaps therebetween, the aggravated area a precursor to formation of at least one callus on the finger surface of the user upon the user repetitively applying pressure manually urging the engaging surfaces from the closed position towards the open position or from the open position towards the closed position.

12. The method according to claim 11,
wherein the operating the compression-resistant device to resist pressure manually applied by a user urging the engaging surfaces from the closed position towards an open position includes operating a torsion resistance member to resist pressure manually applied by a user urging the engaging surfaces from the closed position towards an open position.

13. The method according to claim 11,
wherein the operating the compression-resistant device to resist pressure manually applied by a user urging the engaging surfaces from an open position towards the closed position includes operating includes operating at least first and second resistance members to resist pressure manually applied by a user urging the engaging surfaces from an open position towards the closed position.

14. The method according to claim 11,
wherein operating the compression-resistant device to resist pressure manually applied by a user includes applying pressure against projections from the manual compression surface that extend across the manual compression surface such that the intermittent gaps are bounded only by the manual compression surface.

15. The method according to claim 11,
wherein operating the compression-resistant device to resist pressure manually applied by a user includes applying pressure against the projections from the manual compression surface that extend across the manual compression surface that are bounded by a boundary structure extending from the manual compression surface such that the intermittent gaps are bounded by the manual compression surface and by the boundary structure.

16. The method according to claim 11, wherein the manual compression surface is configured and disposed on a side of at least one of the first and second jaw members that is opposite to a side of each of the first and second jaw members on which are configured and disposed the engaging surfaces.

17. The method according to claim 11,
wherein operating the compression-resistant device to resist pressure manually applied by a user includes applying pressure against projections that define a spiral cross-sectional configuration.

18. The method according to claim 12,
wherein operating the compression-resistant device to resist pressure manually applied by a user includes applying pressure wherein the engaging surfaces intermesh teeth to enable gripping of an object received therebetween.

19. The method according to claim 13,
wherein operating the compression-resistant device to resist pressure manually applied by a user includes applying pressure wherein at least one of the at least first and second resistance members resists compression.

20. The method according to claim 13,
wherein operating the compression-resistant device to resist pressure manually applied by a user includes applying pressure wherein at least one of the at least first and second resistance members resists tension.
